(19) United States
(12) Patent Application Publication
(10) Pub. No.: US 2010/0124952 A1
(43) Pub. Date: May 20, 2010

(54) MOBILE TERMINAL DEVICE

(75) Inventors: Kiyokazu Moriizumi, Kawasaki (JP); Kouhei Ezaki, Kawasaki (JP); Yoshinori Mesaki, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/606,635

(22) Filed: Oct. 27, 2009

(30) Foreign Application Priority Data
Nov. 20, 2008 (JP) 2008-296204

(51) Int. Cl. H04M 1/00

(52) U.S. Cl. 455/575.1

(57) ABSTRACT

A mobile terminal device having communicating functions includes a housing; an antenna housed in the housing to be freely pulled out; a pull-out mechanism that pulls out the antenna from within the housing in accordance with an instruction to pull out the antenna; and an instructing section that gives the instruction to pull-out the antenna to the pull-out mechanism in accordance with a predetermined event for any one of the communicating functions.

### CROSS REFERENCE TO RELATED APPLICATION

This application is based upon and claims the benefit of priority from the prior Japanese Patent Application NO. 2008-296204 filed on Nov. 20, 2008, the entire contents of which are incorporated herein by reference.

### FIELD

The embodiments discussed herein are related to a mobile terminal device equipped with an antenna which is housed in a housing to be freely pulled out from within the housing.

### BACKGROUND

Recently, it has been promoted to mount a camera function for photographing a subject, a browser function for browsing a Web site and a One Segment Broadcasting function for listening and viewing a TV program on a mobile phone in addition to standard talking function and electronic mail transmitting and receiving function. Mobile phones are now being utilized by persons of a wide age group as private multifunction terminals substituting for digital cameras, personal computers and TV sets not only as means for communications.

In relation to the above, a typical TV set or personal computer has a horizontally elongated display screen. On the other hand, a mobile phone has a vertically elongated general form in order to increase one-handed holding property and operability and hence generally its display screen also has a vertically elongated form. Therefore, it is being widely practiced to rotate an upper housing on which the display screen is formed relative to a lower housing equipped with keys so as to display an image horizontally relative to the display screen in the case that a user intends to listen and view a TV program. As described above, the display screen is effectively utilized to realize enlarged display of an image by horizontally laying down the upper housing relative to the lower housing and it becomes possible for the user to listen and view the TV program while vertically holding the mobile phone in one hand.

A technique for automatically setting an operation mode of a mobile electronic device by detecting positional relation between an upper housing and a lower housing is described in Patent Document 1. Labor taken for key operation by a user is saved by utilizing this technique to detect that the upper housing has been laid down horizontally relative to the lower housing and to automatically set the operation mode of the mobile phone to the One Segment Broadcasting mode.

### [Patent Document 1]

Japanese Laid-open Patent Publication (Translation of PCT Application) No. 2003-532351

However, a mobile phone is frequently used in an open area surrounded by buildings. Under the circumstances as mentioned above, its radio wave receiving condition becomes unstable as compared with a typical TV set utilizing a stationary antenna. Therefore, in the case that a user wishes to listen and view a TV program via the mobile phone, it is necessary for the user to first set the operation mode of the mobile phone to the One Segment Broadcasting mode and then pull out the antenna housed in the housing. Thus, the typical mobile phone has such a problem that its operation takes much time and labor.

Incidentally, the same problem generally occurs also in the case that radio communication via an antenna is to be performed using a portable mobile terminal device, not only limited to the case in which the user intends to listen and view the TV program via the mobile phone as mentioned above.

### SUMMARY

According to an aspect of the embodiments, a mobile terminal device that has communicating functions includes: a housing, an antenna housed in the housing to be freely pulled out, a pull-out mechanism that pulls out the antenna from within the housing in accordance with an instruction to pull out the antenna and an instructing section that gives the instruction to pull out the antenna to the pull-out mechanism in accordance with a predetermined event for one communicating function.

The object and advantages of the embodiments will be realized and attained by means of the elements and combinations particularly pointed out in the claims.

It is to be understood that both the foregoing general description and the following detailed description and are exemplary and explanatory and are not restrictive of the embodiments, as claimed.

### BRIEF DESCRIPTION OF DRAWINGS

FIG. 1 is an outer perspective view of a mobile phone according to a first embodiment of a mobile terminal device;

FIG. 2 is a diagram illustrating front surface sides of a lower housing and a coupling member in a state in which an upper housing is removed;

FIG. 3 is a diagram illustrating a rear surface side of the upper housing;

FIG. 4 is an inner block diagram of a mobile phone;

FIG. 5 is a flowchart illustrating a flow of a series of processes performed from when the One Segment Broadcasting mode has been set to when an antenna is pulled out;

FIG. 6 is a diagram illustrating steps of an operation of inclining the upper housing relative to the lower housing;

FIG. 7A is one structural diagram of an antenna and an antenna pull-out section;

FIG. 7B is another structural diagram of the antenna and the antenna pull-out section;

FIG. 8A is a diagram illustrating a mobile phone according to a second embodiment;

FIG. 8B is a diagram illustrating the mobile phone according to the second embodiment;

FIG. 9A is a diagram illustrating a mobile phone according to a third embodiment;

FIG. 9B is a diagram illustrating the mobile phone according to the third embodiment;

FIG. 10 is a diagram illustrating relation between an upper housing and a coupling member of a mobile phone according to a fourth embodiment;

FIG. 11A is a diagram illustrating an operation of inclining the upper housing relative to a lower housing in the mobile phone according to the fourth embodiment;

FIG. 11B is a diagram illustrating the operation of inclining the upper housing relative to the lower housing in the mobile phone according to the fourth embodiment;

FIG. 12 is a diagram illustrating an example of an LCD on which an image of a TV program is displayed in a fifth embodiment;

FIG. 13 is a flowchart illustrating a flow of a series of processes performed until an antenna is pulled out in a sixth embodiment;

FIG. 14A is one structural diagram of an antenna and an antenna pull-out section according to a seventh embodiment;

FIG. 14B is another structural diagram of the antenna and the antenna pull-out section according to the seventh embodiment;

FIG. 15A is one structural diagram of an antenna and an antenna pull-out section according to an eighth embodiment;

FIG. 15B is another structural diagram of the antenna and the antenna pull-out section according to the eighth embodiment;

FIG. 16A is one structural diagram of an antenna and an antenna pull-out section according to a ninth embodiment; and

FIG. 16B is another structural diagram of the antenna and the antenna pull-out section according to the ninth embodiment.

### DESCRIPTION OF EMBODIMENTS

Next, preferred embodiments of the present invention will be described with reference to the accompanying drawings.

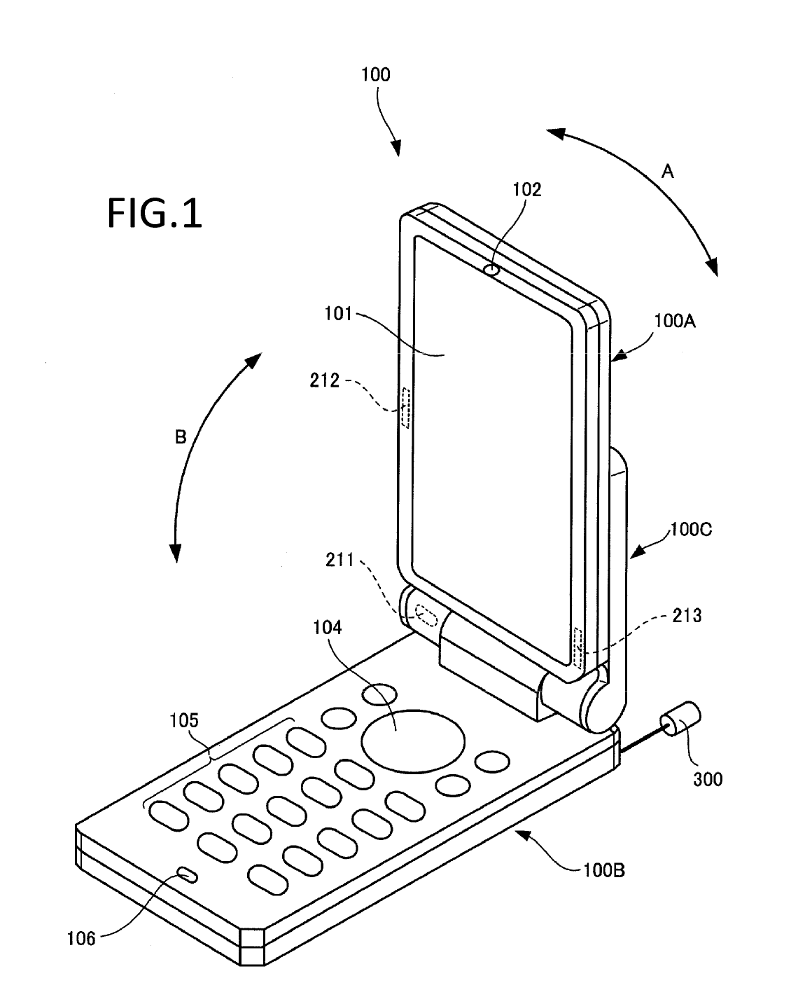

FIG. 1 is an external perspective view of a mobile phone according to a first embodiment of the above mentioned mobile terminal device.

A photographing function for photographing a subject, a browser function for browsing a Web site and a One Segment Broadcasting function for listening and viewing a TV program are mounted on a mobile phone 100 together with data communicating functions for transmitting voice data and electronic mails to an external device and receiving them from the external device.

The mobile phone 100 I includes an upper housing 100A on which a liquid crystal panel 101 is installed, a lower housing 100B which is held by one hand of a user and a coupling member 100C hinged to the lower housing 100B. The upper housing 100A is held by the lower housing 100B via the coupling member 100C so as to be rotationally movable relative to the lower housing 100B in a direction illustrated by an arrow A″ and to be freely opened or closed in a direction illustrated by an arrow B″. A combination of the upper housing 100A with the lower housing 100B corresponds to an example of the above mentioned housing.

A selection button 104 used as a shutter button for selecting various functions and photographing a subject, push buttons 105 used to input a telephone number and an earpiece 106 for transmitting a voice to a built-in microphone are installed on the upper surface of the lower housing 100B and an antenna 300 designed to be freely housed in the housing is attached to one side face of the lower housing 100B. The antenna 300 corresponds to an example of the above mentioned antenna.

A magnetic sensor 211 is built into the coupling member 100C at a position opposite to an edge of the upper housing 100A.

The liquid crystal panel 101 on which a telephone number, a moving image of a TV program or a photographed image is displayed is provided on the upper housing 100A and a mouth piece 102 for outputting a voice uttered from a built-in loudspeaker is installed in the upper housing 100A. In addition, magnets 212 and 213 are built into the upper housing 100A at two positions where the magnets are brought into opposition to the magnetic sensor 211 in the coupling member 100C when the upper housing 100A is rotated in the arrow A″ direction so as to be inclined relative to the lower housing 100B.

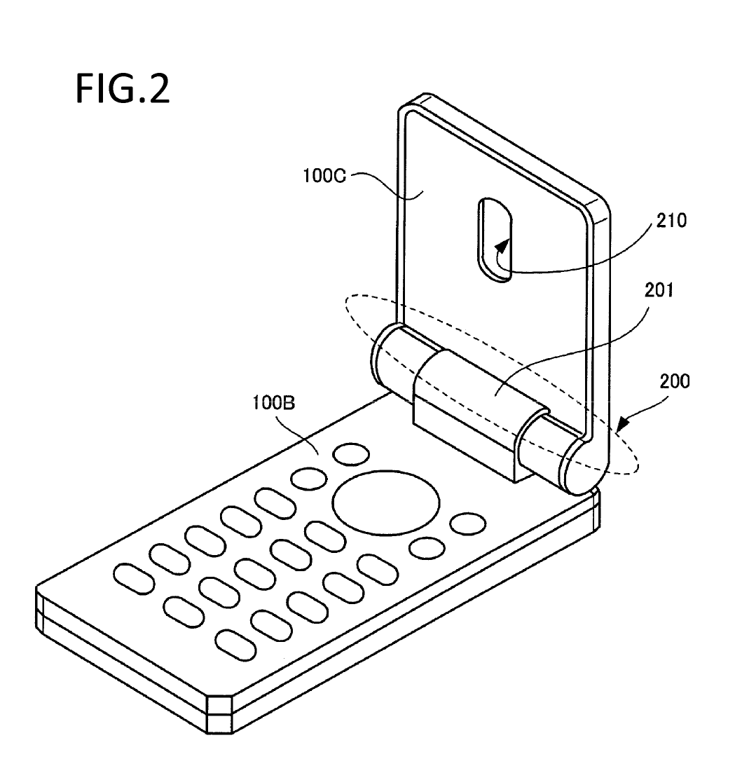

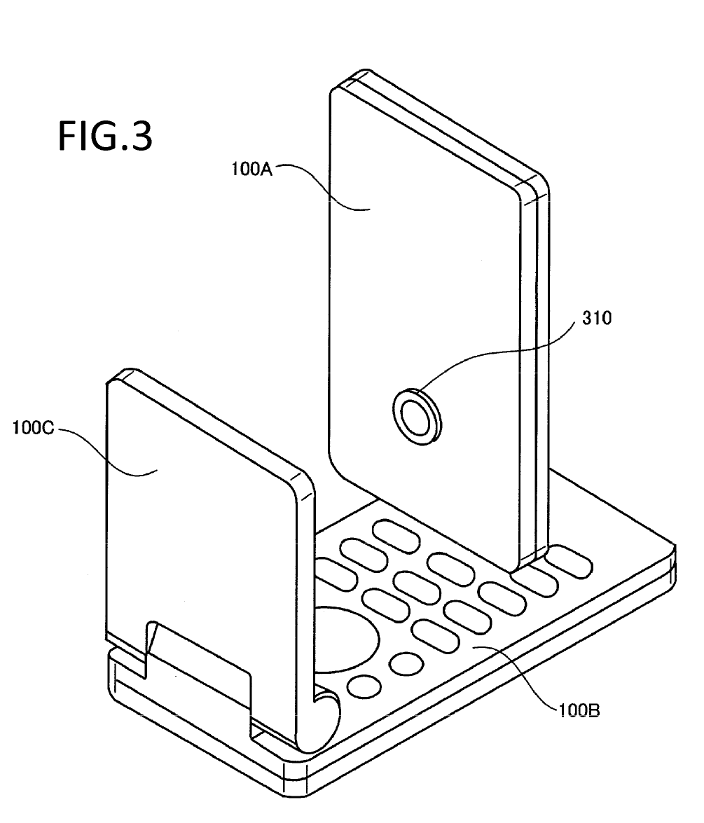

FIG. 2 is a diagram illustrating the front surface sides of the lower housing 100B and the coupling member 100C in a state in which the upper housing 100A has been removed and FIG. 3 is a diagram illustrating the rear surface side of the upper housing 100A.

As illustrated in FIG. 2, the lower housing 100B and the coupling member 100C are coupled together via a hinge part 200 so as to be freely folded. An abutting base 201 against which the upper housing 100A is brought into abutment is formed on the hinge part 200 and a vertically extending vertical groove 210 is formed in the front surface side of the coupling member 100C.

As illustrated in FIG. 3, a protrusion 310 is provided on the rear surface side of the upper housing 100A. The protrusion 310 on the upper housing 100A illustrated in FIG. 3 is fitted into the vertical groove 210 formed in the coupling member 100C illustrated in FIG. 2, thereby supporting the upper housing 100A on the coupling member 100C so as to be rotationally movable.

Next, an inner structure of the mobile phone will be described.

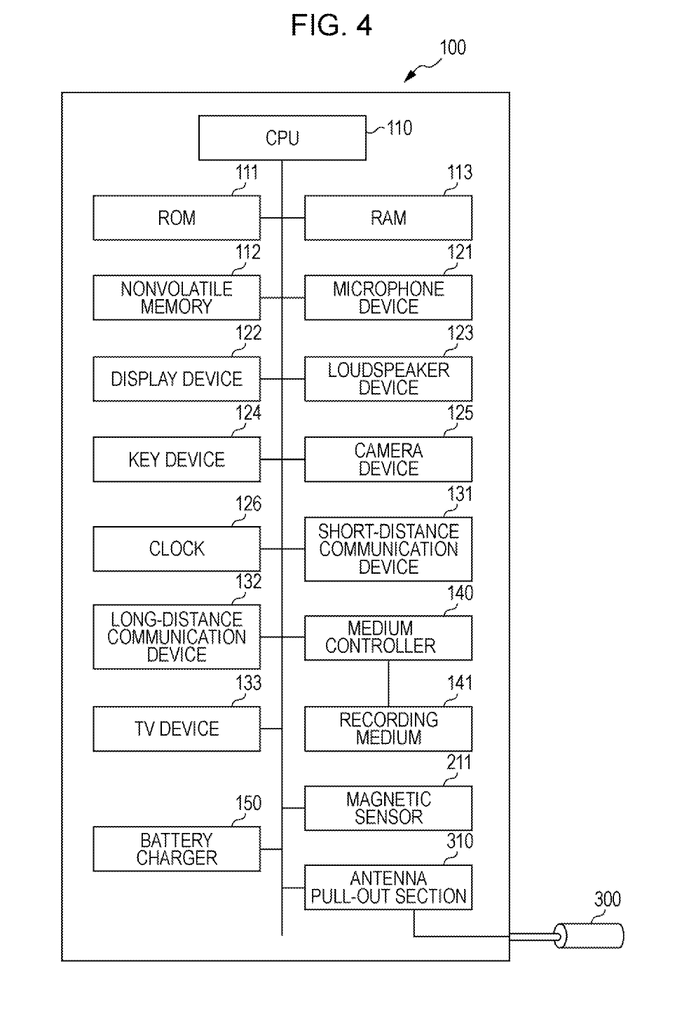

FIG. 4 is an inner block diagram of the mobile phone.

A CPU 110, a ROM 111, a nonvolatile memory 112, a RAM 113, a microphone device 121, a display device 122, a loudspeaker device 123, a key device 124, a camera device 125, a clock 126, a short-distance communication device 131, a long-distance communication device 132, a TV device 133, a medium controller 140, a battery charger 150 and an antenna pull-out section 310 are illustrated in the FIG. 4 in addition to the antenna 300 and the magnetic sensor 211 also illustrated in FIG. 1 and these elements are connected together via a bus.

The CPU 110 has a function to execute various programs and generally controls operations of the mobile phone 100.

Non-rewritable information such as various programs to be executed using the CPU 110 is stored in the ROM 111.

Information which may sometimes be rewritten and is held even when power supply is stopped such as an address book and received electronic mails is stored in the nonvolatile memory 112.

The RAM 113 is a volatile memory in which information is held only while the power is being supplied. The CPU 110 expands a program stored in the ROM 111 or the nonvolatile memory 112 on the RAM 113 and executes the program while using the RAM 113 as a work area.

The microphone device 121 is a functional block that has a microphone that picks up the voice of a user and processes the voice which has been picked up using the microphone.

The loudspeaker device 123 is a functional block that has a loudspeaker that outputs a voice to the user and generates a voice signal used for driving the loudspeaker.

The short-distance communication device 131 functions to transmit an image or a telephone number to an external device situated at a short distance from a mobile phone concerned without passing through a base station and a communication system such as an infrared communication system is adopted for this purpose.

The long-distance communication device 132 functions to transmit and receive voice data and electronic mails via the antenna 300. In the long-distance communication device 132, data transmission and reception is performed via a base station.

The camera device 125 is a block that functions to collect image data obtained by photographing subjects. The display device 122 is a block that functions to display an image on the LCD 101 (see FIG. 1). The key device 124 is a block that detects key operations performed by a user using the various operation keys 104 and 105 (see FIG. 1). The clock 126 is a block that acquires the current time.

The TV device 133 is a block that converts radio waves received using the antenna 300 to digital program data using a tuner and displays an image of a TV program indicated by the program data on the liquid crystal panel 101 (see FIG. 1).

The antenna pull-out section 310 functions to pull out the antenna 300 from within the lower housing 100B in accordance with setting of the One Segment Broadcasting mode for listening and viewing the TV program concerned. The configuration of the antenna pull-out section 310 will be described in detail later. The antenna pull-our section 310 corresponds to an example of the above mentioned pull-out mechanism.

The medium controller 140 functions to read out data from a recording medium 141 and write image data generated using the camera device 125 into the recording medium 141.

The mobile phone 100 is configured as described above in outline and in hardware.

In the mobile phone 100 configured as mentioned above, when the One Segment Broadcasting mode is set in accordance with an operation performed by the user, the TV device 133 is started up to execute a One Segment Broadcasting function that displays the TV program on the LCD 101 and the antenna 300 is automatically pulled out from within the lower housing 100B simultaneously therewith.

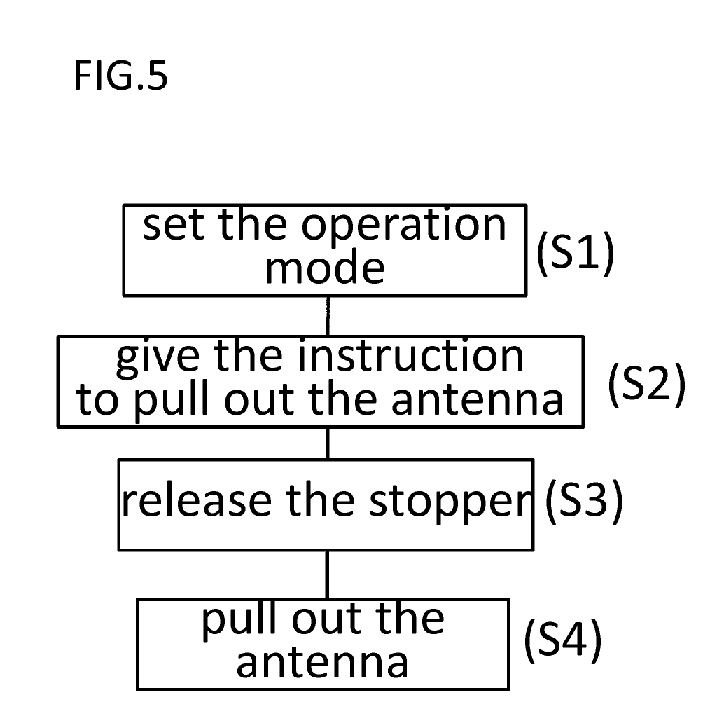

FIG. 5 is a flowchart illustrating a flow of a series of processes performed from when the One Segment Broadcasting mode has been set to when the antenna 300 is pulled out.

When the user operates the mobile phone 100 to instruct to set the One Segment Broadcasting mode, the CPU 110 operates to set the operation mode of the mobile phone 100 to the One Segment Broadcasting mode (step S1 in FIG. 5). In the present embodiment, when the user rotates the upper housing 100A of the mobile phone 100 in the arrow A″ direction to incline the upper housing 100A relative to the lower housing 100B, the operation mode of the mobile phone 100 is set to the One Segment Broadcasting mode.

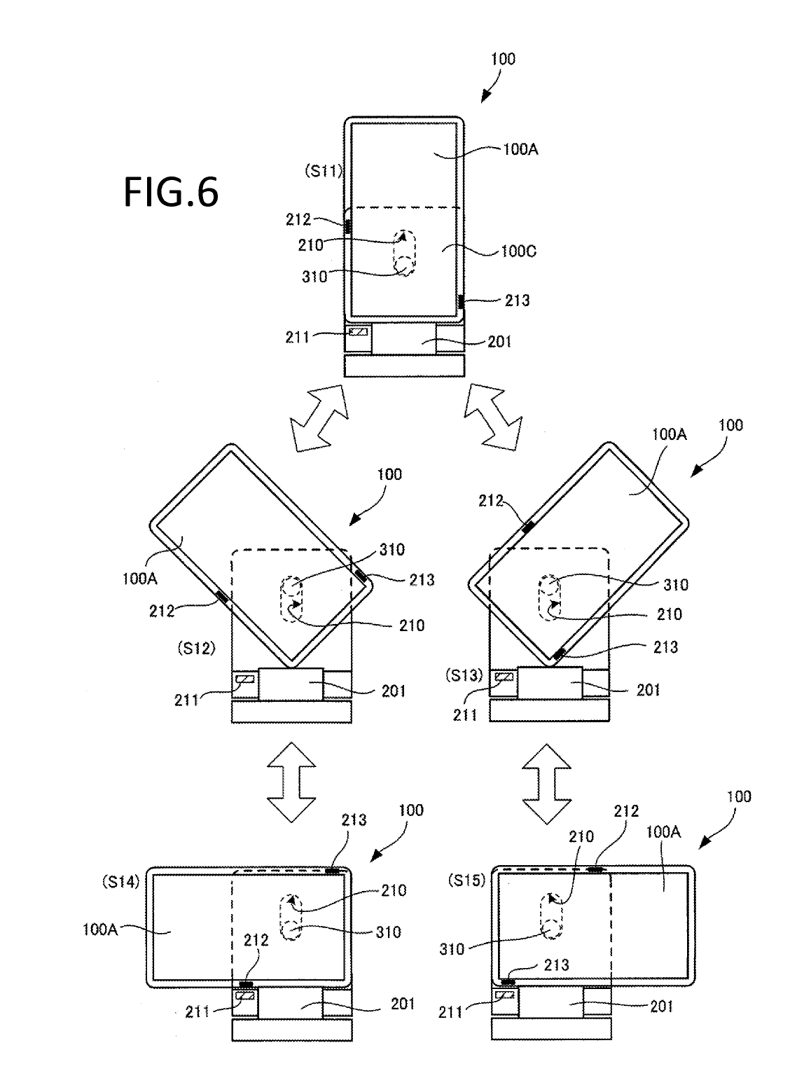

FIG. 6 is a diagram illustrating steps of an operation of inclining the upper housing 100A relative to the lower housing 100B.

In an upright state in which the upper housing 100A is not yet inclined relative to the lower housing 100B (step S11 in FIG. 6), the two magnets 212 and 213 built into the upper housing 100A are not yet opposed to the magnetic sensor 211 built into the coupling member 100C. Thus, in the upright state, any magnetic field is not sensed using the magnetic sensor 211.

When the upper housing 100A is inclined leftward, first, the upper housing 100A rotates as the protrusion 310 moves upward guided along the vertical groove 210 (step S12 in FIG. 6). As the upper housing 100A is further rotated, its left lower corner is guided along the abutting base 201 of the coupling member 100C and the protrusion 310 moves downward guided along the vertical groove 210. As a result, the upper housing 100A is laid down leftward relative to the lower housing (step S14 in FIG. 6). In a leftward laid-down state at step S14, the magnet 212 built into the left side of the upper housing 100A comes into opposition to the magnetic sensor 211 and the magnetic field of the magnet 212 is sensed using the magnetic sensor 211.

On the other hand, when the upper housing 100A is inclined rightward, the upper housing 100A rotates as the protrusion 310 moves upward guided along the vertical groove 210 (step S13 in FIG. 6). As the upper housing 100A is further rotated, the protrusion 310 moves downward, guided along the vertical groove 210. As a result, the upper housing 100A is laid down rightward relative to the lower housing (step S15 in FIG. 6). In a rightward laid-down state at step S15, the magnet 213 built into the right side of the upper housing 100A comes into opposition to the magnetic sensor 211 and the magnetic field of the magnet 213 is sensed using the magnetic sensor 211.

As described above, when the upper housing 100A is inclined relative to the lower housing 100B, the magnet 212 or 213 is moved to a position where it is opposed to the magnetic sensor 211 and the magnetic field of the magnet concerned is sensed using the magnetic sensor 211. That is, rotation of the upper housing 100A is detected by sensing the magnetic field of the magnet concerned using the magnetic sensor 211.

The magnetic sensor 211 that has sensed the magnetic field of the magnet 212 or 213 sends a result of sensing to the CPU 110. In the CPU 110, the rotation of the upper housing 100A is detected by acquiring the result of sensing from the magnetic sensor 211. As a result, the operation mode of the mobile phone 100 is set to the One Segment Broadcasting mode. The CPU 110 corresponds to an example of the above mentioned instructing section.

As an example of application, the fundamental embodiment of the above mentioned mobile terminal device may be favorably configured such that the mobile terminal device further includes a startup sensing section that senses startup of the communicating function in accordance with a predetermined operation and the instructing section gives the instruction to pull out the antenna to the pull-out mechanism in accordance with sensing of startup of the communicating function performed using the startup sensing section.

According to the above mentioned example of the mobile terminal device, it may become possible for the user to automatically give the antenna pull-out instruction by performing an operation of starting-up the communicating function and hence the operation necessary to pull out the antenna is eliminated. A combination of the magnetic sensor 211 with the magnets 212 and 213 corresponds to an example of the above mentioned startup sensing section.

As an example of application, the fundamental embodiment of the above mentioned mobile terminal device may be favorably configured such that the housing includes the upper housing equipped with a display screen and the lower housing that holds the upper housing so as to be freely opened or closed and to be rotationally movable in an in-plane direction of the display screen, the startup sensing section has a rotation sensing sensor that senses rotation of the upper housing and startup of the communicating function is sensed by sensing the rotation of the upper housing the rotation sensing sensor.

Typically, in many cases, the upper housing is rotated relative to the lower housing to set the display screen sideways in the One Segment Broadcasting mode for listening and viewing a TV program. According to the above mentioned favorable example of the mobile terminal device, startup of the One Segment Broadcasting mode is sensed by sensing the rotation of the upper housing, so that the user is allowed to readily set the One Segment Broadcasting mode simply by setting the orientation of the display screen. Incidentally, the upper housing 100A corresponds to an example of the above mentioned upper housing, the lower housing 100B corresponds to an example of the above mentioned lower housing and the magnetic sensor 211 corresponds to an example of the above mentioned rotation sensing sensor.

Further, an example of application that the above mentioned rotation sensing sensor is a magnetic sensor is also favorable.

Utilization of a magnetic sensor as the above mentioned rotation sensing sensor realizes sensing of the rotation of the upper housing by a simple configuration. The magnetic sensor 211 corresponds to an example of the above mentioned magnetic sensor.

When the user lays down the upper housing 100A relative to the lower housing 100B to set the operation mode of the mobile phone 100 to the One Segment Broadcasting mode, an instruction to start up the One Segment Broadcasting function is given from the CPU 110 to the TV device 133 and the antenna pull-out section 310 (step 51).

The TV device 133 operates to display an image of a TV program on the LCD 101 in accordance with the instruction to start up the One Segment Broadcasting function and the antenna pull-out section 310 pulls out the antenna 300 from within the lower housing 100B in accordance with the instruction to start up the One Segment Broadcasting function.

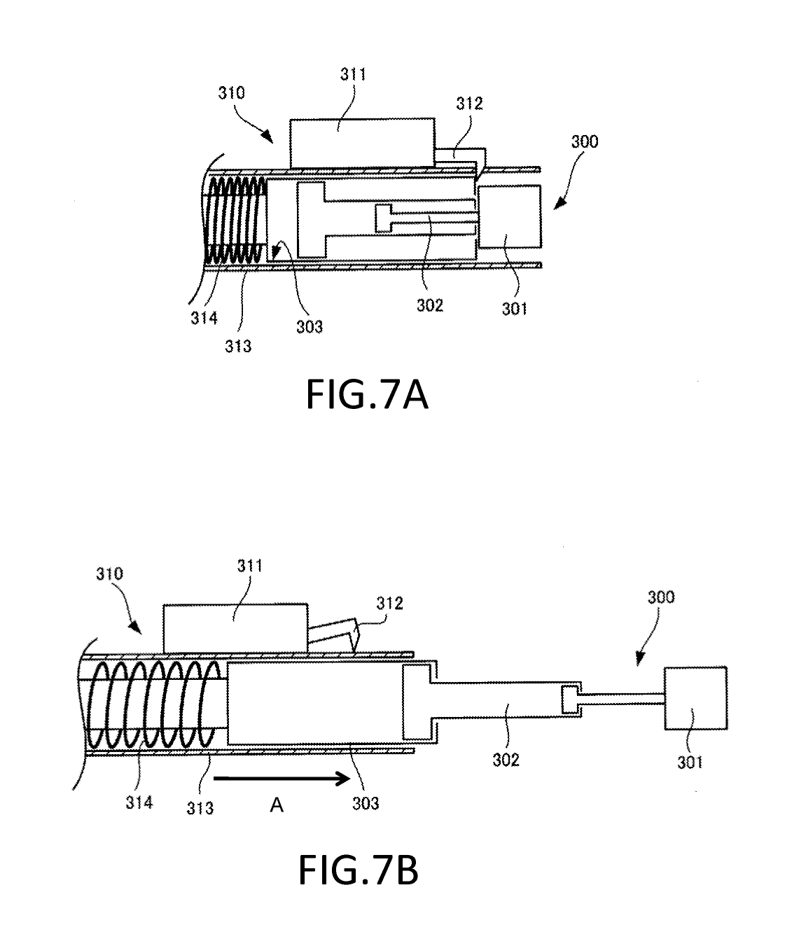

FIGS. 7A and 7B are structural diagrams of the antenna 300 and the antenna pull-out section 310.

FIG. 7A illustrates a state in which the antenna 300 is housed in the lower housing 100B and FIG. 7B illustrates a state in which the antenna 300 has been pulled out from within the lower housing 100B.

As illustrated in FIGS. 7A and 7B, the antenna 300 is constituted by a leading end part 301, a central part 302 and a trailing end part 303. The trailing end part 303 is held in the antenna pull-out section 310. The antenna pull-out section 310 is constituted by a spring 314 that actuates the antenna 300 in a pulling-out direction A, a cylindrical member 313 that guides movement of the antenna 300, a stopper 312 that bocks the movement of the antenna 300 and a release section 311 that releases the stopper 312 and is housed in the lower housing 100B.

The trailing end part 303 of the antenna 300 is inserted into the cylindrical member 313 of the antenna pull-out section 310 and its rear end is actuated using the spring 314. The central part 302 of the antenna 300 is held in the trailing end part 303 so as to be movable in a sideward direction illustrated in FIGS. 7A and 7B and the leading end part 301 is held in the central part so as to be movable in the sideward direction illustrated in FIGS. 7A and 7B.

In a state in which the antenna 300 is housed in the lower housing 100B, the trailing end part 303 of the antenna 300 is pushed into the interior of the cylindrical member 313 against the actuating force of the spring 314 as illustrated in FIG. 7A and the trailing end part 303 and the central part 302 are locked using the stopper 312 of the antenna pull-out section 310 to block their movement.

In the antenna pull-out section 310, when the instruction to start up the One Segment Broadcasting function is given from the CPU 110, the stopper 312 is laid aside using the release section 311 to release locking of the trailing end part 303 and the central part 302. As a result, the trailing end part 303 of the antenna 300 is moved in a direction illustrated by an arrow A along the cylindrical member 313 by the actuating force of the spring 314 and the central part 302 of the antenna 300 is pushed outward from the trailing end part 303 with the aid of moving force of the trailing end part 303.

In the above mentioned manner, the antenna 300 is pulled out from within the lower housing 100B (step S4 in FIG. 5).

Incidentally, as an example of application, the fundamental embodiment of the above mentioned mobile terminal device may be favorably configured such that the pull-out mechanism includes an actuating member that actuates the antenna in a pulling-out direction, a blocking member that blocks pulling-out of the antenna and a release means that releases blocking of pulling-out of the antenna which is exerted using the blocking member in accordance with the instruction to pull out the antenna.

In addition, as an example of application, the fundamental embodiment may be favorably configured such that the actuating member is a spring which is fixed to the housing at its one end and pushes the antenna in the pulling-out direction at its other end relative to the one end thereof.

The antenna is readily pulled out by actuating the antenna by using a spring and releasing locking that blocks pulling-out of the antenna in accordance with the instruction to start up the One Segment Broadcasting function. The spring 314 corresponds to an example of the above mentioned actuating member and an example of the above mentioned spring. The stopper 312 corresponds to an example of the above mentioned blocking member. The release section 311 corresponds to an example of the above mentioned release means.

When the user pushes the leading end part 301 of the antenna 300 against the actuating force of the spring 314, the leading end part 301 is housed in the central part 302 and the central part 302 is housed in the trailing end part 303. Then, the antenna 300 is housed in the lower housing 100B by locking the trailing end part 303 and the central part 302 using the stopper 312 of the antenna pull-out section 310.

As described above, according to the mobile phone 100 of the present embodiment, when the user inclines the upper housing 100A relative to the lower housing 100B, the One Segment Broadcasting function is started up and the antenna 300 is automatically pulled out from within the lower housing 100B simultaneously therewith. As a result, it may become possible to increase the radio wave receiving sensitivity by saving such labor that a user has to manually pull out the antenna 300.

The first embodiment has been described as mentioned above. Next, a second embodiment will be described. The second embodiment is different from the first embodiment in that a photo-interrupter is installed in place of the magnetic sensor 211. Thus, the same numerals are assigned to the same elements as those in the first embodiment and description thereof will be omitted. Only points different from those in the first embodiment will be described.

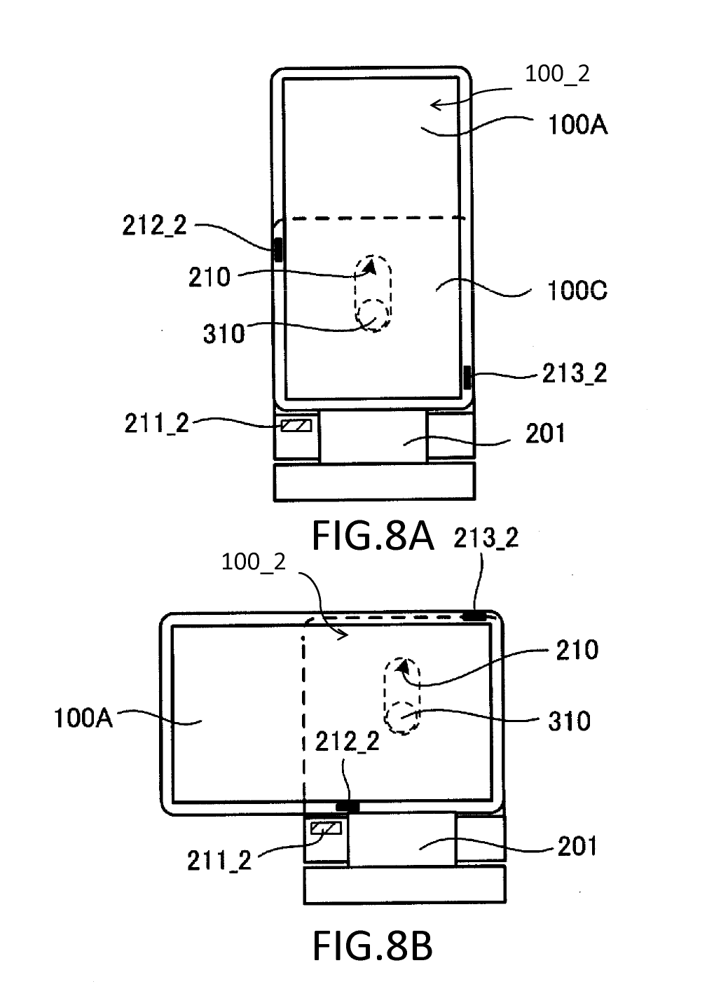

FIGS. 8A and 8B are diagrams illustrating a mobile phone 100_2 according to the second embodiment.

A photo-interrupter 211_2 is built into the coupling member 100C of the mobile phone 100_2 in place of the magnetic sensor 211 in the mobile phone 100 according to the first embodiment illustrated in FIG. 1. Infrared diodes 212_2 and 213_2 are built into the upper housing 100A in place of two magnets 212 and 213.

In an upright state in which the upper housing 100A is not yet inclined relative to the lower housing 100B as illustrated in FIG. 8A, these two infrared diodes 212_2 and 213_2 are not opposed to the photo-interrupter 211_2, so that any infrared ray is not received using the photo-interrupter 211_2.

When the upper housing 100A is laid down relative to the lower housing 100B, the infrared diode 212_2 or 213_2 which is situated on a side toward which the upper housing 100A is laid down comes into opposition to the photo-interrupter 211_2 as illustrated in FIG. 8B. In the example illustrated in FIG. 8B, the upper housing 100A is laid down leftward to bring the left infrared diode 212_2 into opposition to the photo-interrupter 211_2 and the infrared ray which has been emitted from the diode 212_2 is received using the photo-interrupter 211_2.

When the infrared ray is received using the photo-interrupter 211_2, information that the upper housing 100A has been rotated is transmitted to the CPU 110 and the CPU 110 operates to set the operation mode of the mobile phone 100 to the One Segment Broadcasting mode.

Incidentally, in an example of application of the mobile terminal device having the rotation sensing sensor, the rotation sensing sensor may be favorably the photo-interrupter.

The photo-interrupter 211_2 corresponds to an example of the above mentioned photo-interrupter.

As described above, rotation of the upper housing 100A is readily detected also by providing the photo-interrupter 211_2 and the infrared diodes 212_2 and 213_2.

The second embodiment has been described above. Next, a third embodiment will be described. The third embodiment is different from the first embodiment in that inclination sensors are installed in place of the magnetic sensor 211. Thus, the same numerals are assigned to the same elements as those in the first embodiment and description thereof will be omitted. Only points different from those in the first embodiment will be described.

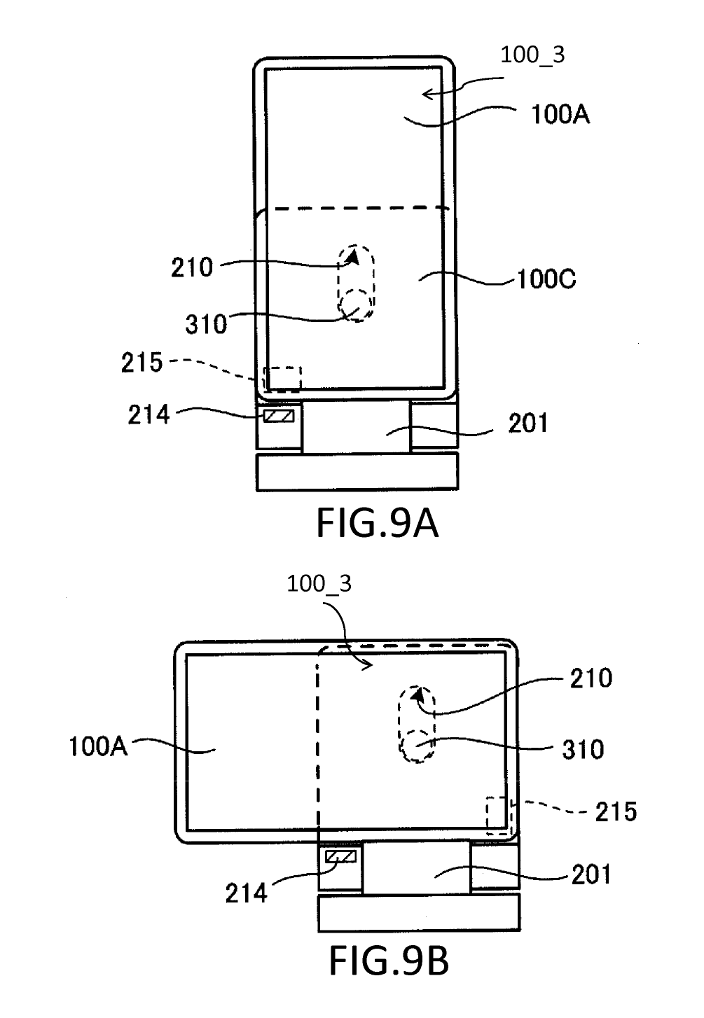

FIGS. 9A and 9B are diagrams illustrating a mobile phone 100_3 according to the third embodiment.

Inclination sensors 214 and 215 that sense inclination are built into the coupling member 100C and the upper housing 100A of the mobile phone 100_3. The inclination sensor 214 built into the coupling member 100C senses the inclination of the entire mobile phone 100_3 and the inclination sensor 215 built into the upper housing 100A senses inclination that occurs when the upper housing 100A has been rotated in addition to the inclination of the entire mobile phone 100_3.

In an upright state in which the upper housing 100A is not yet inclined relative to the lower housing 100B as illustrated in FIG. 9A, any inclination is not sensed using two inclination sensor 214 and 215.

In addition, for example, in the case that a user has let fall the mobile phone 100-3 which is in the upright state illustrated in FIG. 9A, the upper housing 100A, the lower housing 100B and the coupling member 100C are integrally inclined and hence the inclination that occurs in the above mentioned situation is sensed using both the two inclination sensors 214 and 215. Results of sensing performed using the inclination sensors 214 and 215 are sent to the CPU 110. In the case that the results of sensing are sent from both the inclination sensors 214 and 215, the CPU 110 does not operate to set the One Segment Broadcasting mode.

When the upper housing 100A is laid down relative to the lower housing 100B, since the lower housing 100B and the coupling member 100C are not inclined as illustrated in FIG. 9B, any inclination is not sensed using the inclination sensor 214 which is built into the coupling member 100C and inclination is sensed using only the inclination sensor 215 which is built into the upper housing 100A. In the CPU 110, in the case that the inclination has been sensed using only the inclination sensor 215 built into the upper housing 100A, rotation of the upper housing 100A is detected and the operation mode of the mobile phone 100 is set to the One Segment Broadcasting mode.

Incidentally, as an example of application, the mobile terminal device having the rotation sensing sensor may be favorably configured such that the rotation sensing sensor is constituted by a first inclination sensor provided in the lower housing to sense the inclination of the lower housing and a second inclination sensor provided in the upper housing to sense the inclination of the upper housing and when any inclination has not been sensed using the first inclination sensor and the inclination has been sensed using the second inclination sensor, rotation of the upper housing is sensed.

The inclination sensor 214 built into the coupling member 100C corresponds to an example of the above mentioned first inclination sensor and the inclination sensor 215 built into the upper housing 100A corresponds to an example of the above mentioned second inclination sensor.

As described above, accurate detection of the rotation of the upper housing 100A is realized by providing the inclination sensors not only in the upper housing 100A but also in the lower housing 100B and the coupling member 100C.

The third embodiment has been described above. Next, a fourth embodiment will be described. The fourth embodiment is different from the first embodiment in that a mechanical switch is provided in place of the magnetic sensor 211. In the fourth embodiment, the same numerals are assigned to the same elements as those in the first embodiment and hence description thereof will be omitted. Only points different from those in the first embodiment will be described.

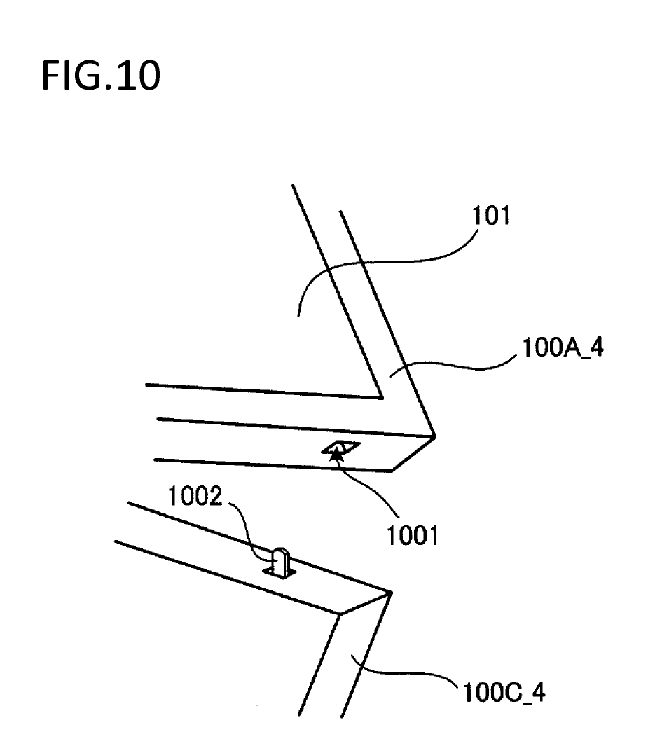

FIG. 10 is a diagram illustrating an upper housing 100A_4 and a coupling member 100C_4 of a mobile phone 100_4 according to the fourth embodiment.

As illustrated in FIG. 10, in the mobile phone 100_4 according to the fourth embodiment, a hole 1001 is formed in a lower edge of the upper housing 100A_4 and a mechanical switch 1002 is attached to the coupling member 100C_4 at a position where the switch faces the hole 1001 in the upright state illustrated at step S11 in FIG. 6.

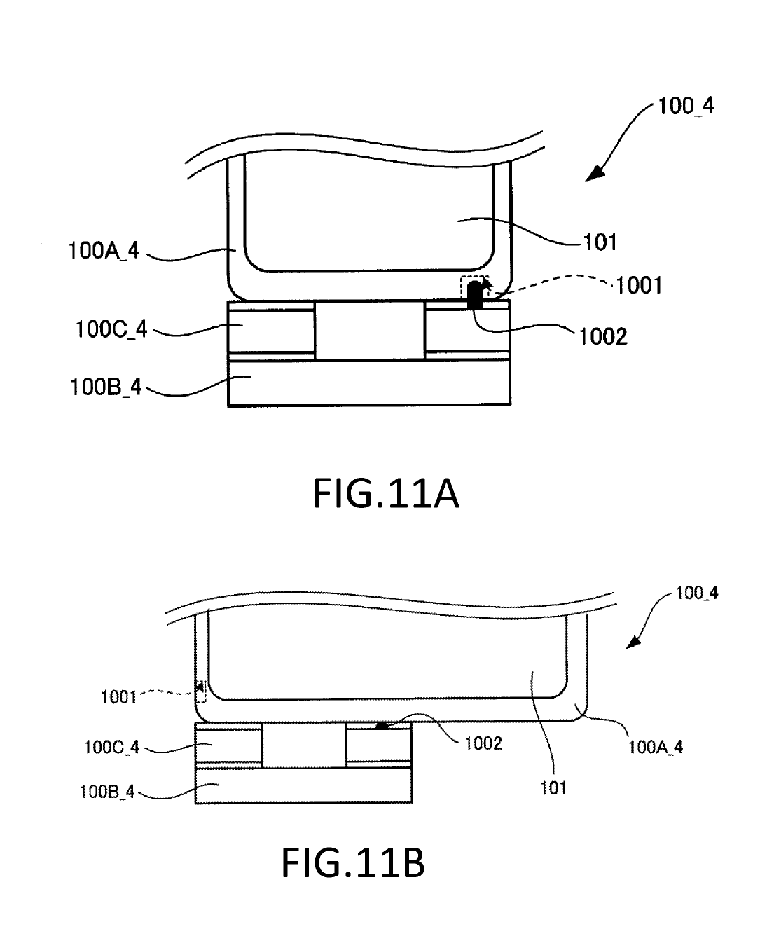

FIGS. 11A and 11B are diagrams illustrating an operation of inclining the upper housing 100A_4 relative to the lower housing 100B_4.

In an upright state illustrated in FIG. 11A, the mechanical switch 1002 attached to the coupling member 100C_4 is inserted into the hole 1001 formed in the lower edge of the upper housing 100A_4 and hence the mechanical switch 1002 is not depressed.

When the upper housing 100A_4 is inclined relative to the lower housing 100B_4, the mechanical switch 1002 is depressed using the upper housing 100A_4 as illustrated in FIG. 11B.

As an example of application of the mobile terminal device having the rotation sensing sensor, the rotation sensing sensor is preferably a mechanical switch.

The mechanical switch 1002 corresponds to an example of the above mentioned mechanical switch. Ready detection of the rotation of the upper housing 100A_4 is also realized by using the mechanical switch 1002.

The fourth embodiment has been described as mentioned above. Next, a fifth embodiment will be described. The fifth embodiment is different from the first embodiment in that pulling-out of the antenna 300 is instructed under the operation of the selection button 104. In the fifth embodiment, the same numerals are assigned to the same elements as those in the first embodiment and hence description thereof will be omitted. Only points different from those in the first embodiment will be described.

In the mobile phone according to the fifth embodiment, a user rotates the upper housing 100A relative to the lower housing 100B to set the operation mode of the mobile phone to the One Segment Broadcasting mode as in the case with the mobile phone 100 according to the first embodiment illustrated in FIG. 1. In the present embodiment, although the instruction to start up the One Segment Broadcasting function is sent from the CPU 110 to the TV device 133 and the display device 122, this start-up instruction is not sent to the antenna pull-out section 210.

The TV device 133 operates to display an image of a TV program on the LCD 101 in accordance with the instruction to start up the One Segment Broadcasting function and the display device 122 operates to display an antenna pull-out button on the LCD 101 in accordance with the instruction to start up the One Segment Broadcasting function.

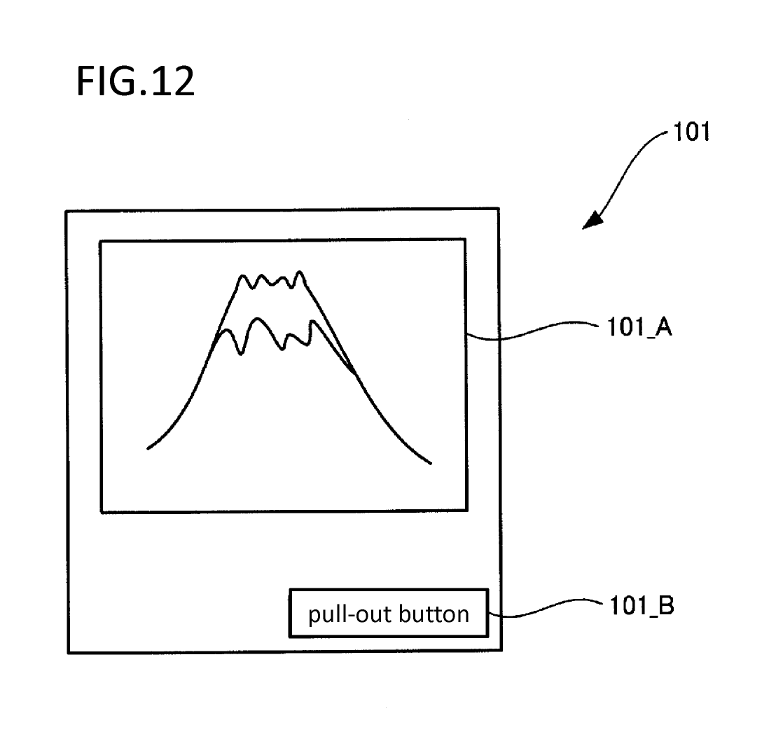

FIG. 12 is a diagram illustrating an example of the LCD 101 on which an image of a TV program is displayed.

As illustrated in FIG. 12, the image of the TV program concerned is displayed in a TV area 101A on the LCD 101 and an antenna pull-out button 101_B is also displayed outside the IV area 101A.

When a user selects the antenna pull-out button 101_B by using the selection button 104 illustrated in FIG. 1, details of selection are transmitted to the CPU 110 via the key device 124.

The CPU 110 operates to instruct the antenna pull-out section 310 to pull out the antenna 300 in accordance with selection of the antenna pull-out button 101_B.

Incidentally, as an example of application, the fundamental embodiment of the above mentioned mobile terminal device may be favorably configured such that the housing includes a plurality of keys used to input an instruction in accordance with an operation performed by a user and the start-up sensing section is configured to sense startup of a communicating function in accordance with the operation of a predetermined key of the plurality of keys.

The selection button 104 corresponds to an example of the above mentioned key. According to the fifth embodiment, automatic pulling-out of the antenna is realized in accordance with key operation performed by a user, not when the One Segment Broadcasting mode has been set.

The Fifth embodiment has been described as mentioned above. Next, a sixth embodiment will be described. The sixth embodiment is different from the first embodiment in that pulling-out of the antenna 300 is instructed in accordance with a radio wave receiving condition of the antenna 300. In the present embodiment, the same numerals are assigned to the same elements as those in the first embodiment and hence description thereof will be omitted. Only points different from those in the first embodiment will be described.

In the mobile phone according to the sixth embodiment, pulling-out of the antenna 300 is instructed not when the One Segment Broadcasting mode has been set but when a received level of radio waves received via the antenna 300 has been lowered while a communicating function such as a TV program listening and viewing function, an electronic mail transmitting/receiving function or a Web site browsing function is being used via the mobile phone.

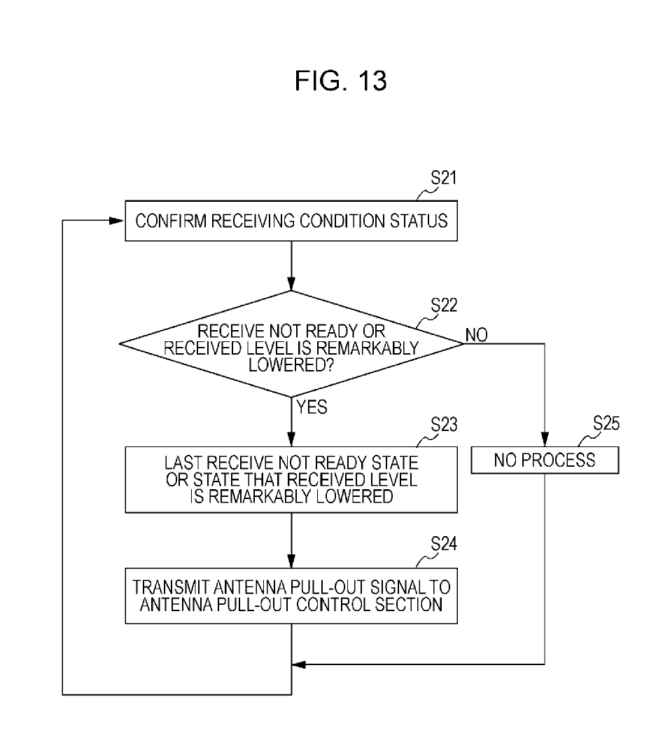

FIG. 13 is a flowchart illustrating a flow of a series of processes performed until the antenna 300 is pulled out.

In the present embodiment, the antenna 300 has a received intensity sensor that senses a received intensity of radio waves. In the received intensity sensor, the received intensity is sensed at each predetermined timing and a result of sensing is sent to the CPU 110 while a communicating function is being used via the mobile phone. The received intensity sensor is of the existing type which is typically mounted on a mobile phone and detailed description thereof will be omitted.

In the CPU 110, a result of sensing which has been sent from the sensor at each predetermined timing is acquired (step S21 in FIG. 13) and the result of sensing is compared with a predetermined threshold value which has been set in advance.

In the case that the received intensity of radio waves received via the antenna 300 is not less than the predetermined threshold value (No at step S22 in FIG. 13), the process is put on standby until the next result of sensing is obtained (step S25 in FIG. 13).

On the other hand, when the received intensity of radio waves received via the antenna 300 is not more than the predetermined threshold value or any radio wave is not received via the antenna 300 (Yes at step S22 in FIG. 13) and this state lasts (step S23 in FIG. 13), the CPU operates to instruct the antenna pull-out section 310 to pull out the antenna 300 (step S24 in FIG. 13).

Incidentally, as an example of application, the fundamental embodiment of the above mentioned mobile terminal device may be favorably configured such that the device includes a level sensing section that senses that the received level of radio waves received via the antenna has become not more than the predetermined threshold value and the instructing section gives a pulling-out instruction to the pull-out mechanism in accordance with sensing performed using the level sensing section.

The received intensity sensor (not illustrated in the drawing) that senses the received intensity of radio waves received via the antenna 300 corresponds to an example of the above mentioned level sensing section.

Pulling-out of the antenna 300 is instructed in the case that the received intensity of radio waves is not more than the predetermined threshold value. As a result, automatic puling-out of the antenna 300 is realized in the case that a user has moved to a place where the radio wave receiving condition is bad while the user is talking over the mobile phone.

The sixth embodiment has been described as mentioned above. Next, a seventh embodiment will be described. The seventh embodiment is different from the first embodiment in the configuration of the antenna pull-out section that pulls out the antenna 300. In the present embodiment, the same numerals are assigned to the same elements as those in the first embodiment and hence description thereof will be omitted. Only points different from those in the first embodiment will be described.

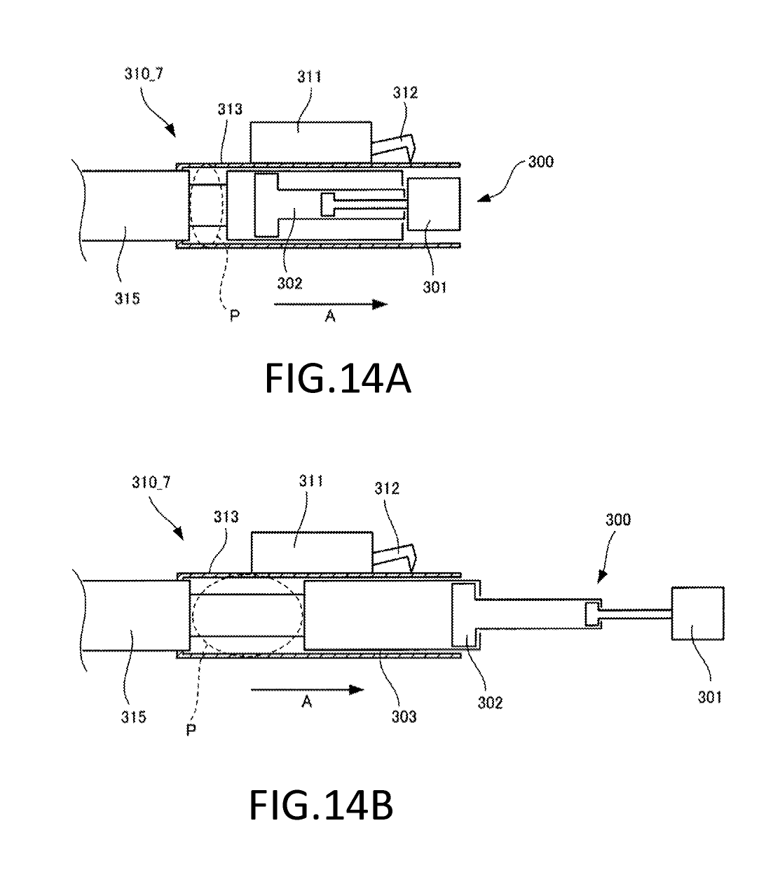

The mobile phone according to the seventh embodiment includes an antenna pull-out section 310_7 (see FIGS. 14A and 14B) that utilizes actuating force exerted with compressed gas in place of the antenna pull-out section 310 that utilizes the actuating force exerted by the spring 314 illustrated in FIGS. 4 and 7.

FIGS. 14A and 14B are structural diagrams of the antenna 300 and the antenna pull-out section 310J.

FIG. 14A illustrates a state in which the antenna 300 is housed in the lower housing 100B and FIG. 14B illustrates a state in which the antenna 300 has been pulled out from within the lower housing 100B.

As illustrated in FIGS. 14A and 14B, the antenna pull-out section 310_7 has the cylindrical member 313, the stopper 312 and the release section 311 as in the case with the antenna pull-out section 310 according to the first embodiment illustrated in FIG. 7. However, the antenna pull-out section 310-7 according to the seventh embodiment does not include the spring 314 illustrated in FIG. 7 and air is filled with no leakage in the cylindrical member 313 and a compression pump 315.

In a state that the antenna 300 is housed in the lower housing 100B, the trailing end part 303 of the antenna 300 is pushed into the interior of the cylindrical member 313 to compress the air which is filled with no leakage in a space P in the cylindrical member as illustrated in FIG. 14A. As a result, the antenna 300 is actuated in the pulling-out direction (the direction illustrated by the arrow A) with the aid of the air in the space P and the stopper 312 of the antenna pull-out section 310_7 locks the trailing end part 303 and the central part 302 of the antenna 300.

When the instruction to start up the One Segment Broadcasting function is given from the CPU 110 to the antenna pull-out section 310_7, the stopper 312 is laid aside using the release section 311 to release locking of the trailing end part and the central part as in the case with the antenna pull-out section 310 according to the first embodiment illustrated in FIG. 7. As a result, the trailing end part 303 of the antenna 300 is actuated with the compressed air in the space P to pull the antenna 300 outside the lower housing 100B as illustrated in FIG. 14B.

In the case that the antenna 300 is to be housed in the lower housing 100B, if the user pushes the leading end part 301 of the antenna 300 in a direction opposite to the pulling-out direction (a direction opposite to the arrow A direction), the leading end part 301 of the antenna 300 will be housed in the central part 302, the central part 302 will be housed in the trailing end part 303 and then the trailing end part 303 and the central part 302 will be locked using the stopper 312 of the antenna pull-out section 310_7.

Incidentally, as an example of application of the mobile terminal device including the pull-out mechanism having the actuating member, the blocking member and the release means, the actuating member may be favorably constituted by a cylinder member that guides movement of the antenna in the pulling-out direction and gas filled with no leakage in the cylinder member and compressed by force exerted when the antenna is housed.

The cylindrical member 313 corresponds to an example of the above mentioned cylinder member and the air which is filled with no leakage in the space P corresponds to an example of the above mentioned gas.

As described above, ready pulling-out of the antenna 300 is also realized by utilizing the compressed air in place of the spring so as to reduce complexity of the device.

The seventh embodiment has been described as mentioned above. Next, an eighth embodiment will be described. The eighth embodiment is different from the first embodiment only in the configuration of the antenna pull-out section. Thus, the same numerals are assigned to the same elements as those in the first embodiment and description thereof will be omitted. Only points different from those in the first embodiment will be described.

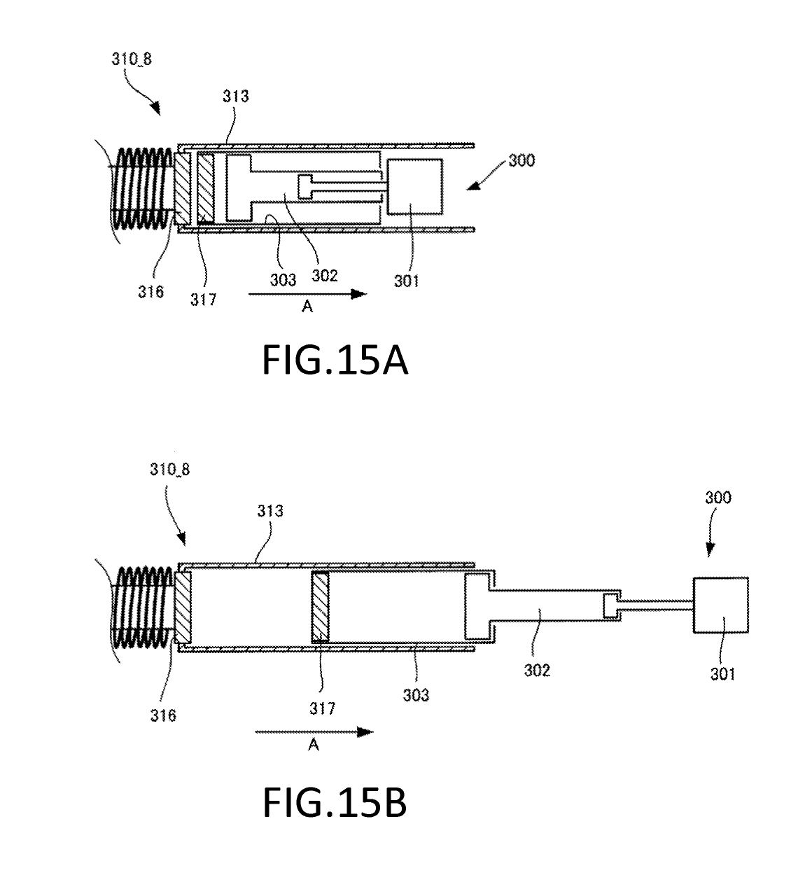

The mobile phone according to the eighth embodiment includes an antenna pull-out section 310_8 using an electromagnet (see FIGS. 15A and 51B) in place of the antenna pull-out section 310 according to the first embodiment that uses the actuating force of the spring 314.

FIGS. 15A and 15B are structural diagrams of the antenna 300 and the antenna pull-out section 310_8.

FIG. 15A illustrates a state in which the antenna 300 is housed in the lower housing 100B and FIG. 15B illustrates a state in which the antenna 300 has been pulled out from within the lower housing 100B.

As illustrated in FIGS. 15A and 15B, in the antenna pull-out section 310-8, an electromagnet 316 is attached to a rear end of the cylindrical member 313 of a cylindrical form. In the antenna 300, a magnet 317 is attached to a rear end of the trailing end part 303.

In a state in which an instruction to pull out the antenna 300 is not yet given to the antenna pull-out section 310-8, the antenna 300 is housed in the cylindrical member 313 as illustrated in FIG. 15A.

For example, in the case that a user has instructed to set the One Segment Broadcasting mode by rotating the upper housing 100A or the received intensity of radio waves received via the antenna 300 has been reduced, the CPU 110 operates to give the instruction to pull out the antennal 300 to the antenna pull-out section 310_8. Then, in the antenna pull-out section 310-8, the direction of current applied to the electromagnet 316 is controlled to adjust the polarity of the electromagnet 316 such that the electromagnet 316 and the magnet 317 may repel each other. As a result, the electromagnet 316 and the magnet 317 repel each other to push out the antenna 300 in the pulling-out direction (the arrow A direction) and the antenna 300 is pulled outside the lower housing 100B as illustrated in FIG. 15B.

In addition, for example, when the user brings the upper housing 100A back to its original position to stand it upright relative to the lower housing 100B, the CPU 110 operates to give an instruction to house the antenna 300 to the antenna pull-out section 310_8.

When the instruction to house the antenna 300 is acquired, in the antenna pull-out section 310_8, the direction of current applied to the electromagnet 316 is controlled to reverse the polarity of the electromagnet 316 such that the electromagnet 316 and the magnet 317 may attract each other. As a result, the electromagnet 316 and the magnet 317 attract each other to pull the antenna 300 in a housing direction (opposite to the arrow A direction) and the antenna 300 is housed in the lower housing 100B as illustrated in FIG. 15A.

As an alternative example of the fundamental embodiment of the above mentioned mobile terminal device, the above mentioned pull-out mechanism may be favorably configured such that it is energized to move the antenna in the pulling-out direction or the housing direction in accordance with a direction in which it is energized.

In addition, the pull-out mechanism may favorably include a magnet which is fixed to the antenna and an electromagnet which is fixed to the housing so as to reverse its magnetism in accordance with the energized direction to attract or repel the magnet.

The magnet 317 corresponds to an example of the above mentioned magnet and the electromagnet 316 corresponds to an example of the above mentioned electromagnet.

As described above, automatic pulling-out of the antenna 300 from within the lower housing 100B and automatic housing of the antenna 300 in the lower housing 100B are realized by attaching the magnet 317 to the antenna 300 and attaching the electromagnet 316 to the antenna pull-out section 310_8 so as to adjust the magnetic pole of the electromagnet 316 in accordance with the instructions to house and pull out the antenna 300.

The eighth embodiment has been described as mentioned above. Next, a ninth embodiment will be described. The ninth embodiment is different from the first embodiment only in the configuration of the antenna pull-out section. Thus, the same numerals are assigned to the same elements as those in the first embodiment and description thereof will be omitted. Only points different from those in the first embodiment will be described.

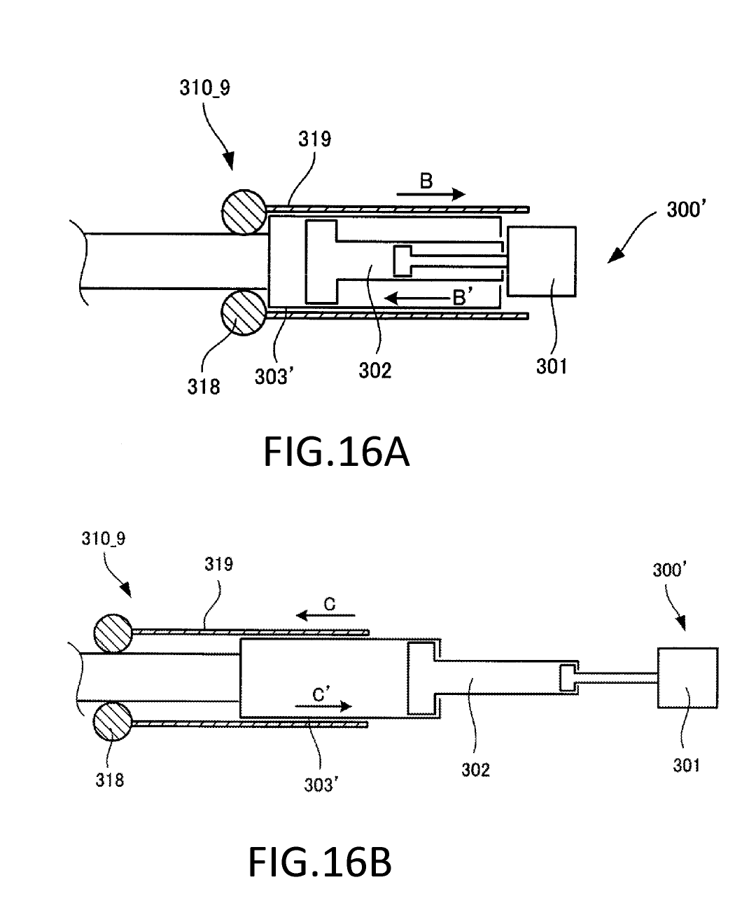

The mobile phone according to the present embodiment includes an antenna pull-out section 310_9 (see FIGS. 16A and 16B) using rollers in place of the antenna pull-out section 310 according to the first embodiment using the actuating force of the spring 314.

FIGS. 16A and 16B are structural diagrams of an antenna 300′ and the antenna pull-out section 310_9.

FIG. 16A illustrates a state in which the antenna 300′ is housed in the lower housing 100B and FIG. 16B illustrates a state in which the antenna 300′ has been pulled out from within the lower housing 100 B.

As illustrated in FIGS. 16A and 16B, the antenna pull-out section 310_9 includes rollers 318 that rotate forward or backward in accordance with a direction in which the pull-out section is energized and a cylindrical member 319 that moves in a direction illustrated by an arrow B or C in cooperation with rotation of the rollers 318. A cam mechanism is interposed between the cylindrical member 319 of the antenna pull-out section 310-9 and a trailing end part 303′ of the antenna 300′ such that as the cylindrical member 310 moves in the arrow B or C direction, the antenna 300′ moves in an arrow B′ or C′ direction opposite to the arrow B or C direction.

When an instruction to pull out the antenna 300′ is sent from the CPU 110 to the antenna pull-out section 310_9, in the antenna pull-out section 310_9, the rollers 318 rotate forward to move the cylindrical member 319 in the arrow C direction. As a result, the antenna 300′ is moved in the arrow C′ direction opposite to the moving direction of the cylindrical member 319 and hence the antenna 300′ is pulled outside the lower housing 100B as illustrated in FIG. 16B.

On the other hand, when an instruction to house the antenna 300′ is sent from the CPU 110 to the antenna pull-out section 310-9, in the antenna pull-out section 310-9, the rollers 318 rotate backward to move the cylindrical member 319 in the arrow B direction. As a result, the antenna 300′ is moved in the arrow B′ direction opposite to the moving direction of the cylindrical member 319 and hence the antenna 300′ is housed in the lower housing 100B as illustrated in FIG. 16A.

Incidentally, as an example of application, a mobile terminal device including a pull-out mechanism which is energized to move the antenna in the pulling-out direction or the housing direction may be favorably configured such that the pull-out mechanism includes rollers that rotate in a direction in accordance with a direction in which it is energized and a moving means which is coupled to both the rollers and the antenna to move the antenna in a direction in accordance with a rotating direction of the rollers.

The rollers 318 correspond to an example of the above mentioned rollers and the cylindrical member 319 corresponds to an example of the above mentioned moving means.

As described above, automatic pulling-out and housing of the antenna 300′ are realized also by moving the antenna 300′ in accordance with the rotating direction of the rollers 318.

Incidentally, although in the above mentioned embodiments, a mobile phone is given as an example of the above mentioned mobile terminal device, the mobile terminal device may be a PDA (Personal Digital Assistant) or a mobile game machine.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. A mobile terminal device having communicating functions, comprising:
a housing;
an antenna housed in the housing to be freely pulled out;
a pull-out mechanism that pulls out the antenna from within the housing in accordance with an instruction to pull out the antenna; and
an instructing section that gives the instruction to pull-out the antenna to the pull-out mechanism in accordance with a predetermined event for any one of the communicating functions.

2. The mobile terminal device according to claim 1, further comprising:
a startup sensing section that senses startup of the communicating function in accordance with a predetermined operation, wherein the instructing section gives the instruction to pull out the antenna to the pull-out mechanism in accordance with sensing of startup of the communicating function performed using the startup sensing section.

3. The mobile terminal device according to claim 1, further comprising:
a level sensing section that senses that the received level of radio waves received via the antenna has become not more than a predetermined threshold value, wherein the instructing section gives the instruction to pull out the antenna to the pull-out mechanism in accordance with sensing performed using the level sensing section.

4. The mobile terminal device according to claim 1, wherein the pull-out mechanism has an actuating member that actuates the antenna in the pulling-out direction, a blocking member that blocks pulling-out of the antenna and a release means that releases blocking of pulling-out of the antenna performed using the blocking member in accordance with the instruction to pull out the antenna.

5. The mobile terminal device according to claim 4, wherein the actuating member is a spring which is fixed to the housing at its one end and pushes the antenna in the pulling-out direction at its other end relative to the one end.

6. The mobile terminal device according to claim 4, wherein the actuating member is constituted by a cylinder member that guides movement of the antenna in the pulling-out direction and gas which is filled with no leakage in the cylinder member and is compressed by force exerted when the antenna is housed.

7. The mobile terminal device according to claim 1, wherein the pull-out mechanism is energized and moves the antenna in the pulling-out direction or the housing direction in accordance with a direction in which it is energized.

8. The mobile terminal device according to claim 2, wherein the pull-out mechanism is energized and moves the antenna in the pulling-out direction or the housing direction in accordance with a direction in which it is energized.

9. The mobile terminal device according to claim 7, wherein the pull-out mechanism has a magnet which is fixed to the antenna and an electromagnet which is fixed to the housing and attracts or repels the magnet by reversing the magnetism in accordance with the energized direction.

10. The mobile terminal device according to claim 7, wherein the pull-out mechanism has rollers that rotate in a direction in accordance with the energized direction and a moving means which is fixed to both the rollers and the antenna to move the antenna in a direction in accordance with rotation of the rollers.

11. The mobile terminal device according to claim 2,
wherein the housing has an upper housing having a display screen and a lower housing that holds the upper housing so as to be freely opened or closed and to be rotationally movable in an in-plane direction of the display screen, and
wherein the startup sensing section has a rotation sensing sensor that senses rotation of the upper housing and the rotation of the upper housing is sensed using the rotation sensing sensor to sense startup of the communicating function.

12. The mobile terminal device according to claim 11, wherein the rotation sensing sensor is a magnetic sensor.

13. The mobile terminal device according to claim 11, wherein the rotation sensing sensor is a mechanical switch.

14. The mobile terminal device according to claim 11, wherein the rotation sensing sensor is a photo-interrupter.

15. The mobile terminal device according to claim 11,
wherein the rotation sensing sensor has a first inclination sensor which is provided in the lower housing so as to sense inclination of the lower housing and a second inclination sensor which is provided in the upper housing so as to sense inclination of the upper housing, and
wherein in the case that any inclination has not been sensed using the first inclination sensor and the inclination has been sensed using the second inclination sensor, the rotation of the upper housing is sensed.

16. The mobile terminal device according to claim 2,
wherein the housing has a plurality of keys used to input an instruction in accordance with an operation, and
wherein the startup sensing section senses the startup of the communicating function in accordance with the operation of a predetermined key of the plurality of keys.
